(19) United States
(12) Patent Application Publication
(10) Pub. No.: US 2020/0148863 A1
(43) Pub. Date: May 14, 2020

(54) Vulcanizable composition comprising HXNBR latex and polyfunctional epoxide

(71) Applicant: ARLANXEO DEUTSCHLAND GMBH, Dormagen (DE)

(72) Inventors: Susanna LIEBER, Kaiserlautern (DE); Karola SCHNEIDERS, Bergisch Gladbach (DE)

(21) Appl. No.: 16/603,448

(22) PCT Filed: Mar. 29, 2018
(86) PCT No.: PCT/EP2018/058147

§ 371 Date: Oct. 7, 2019

(30) Foreign Application Priority Data
Apr. 10, 2017 (EP) 17165819.8

(51) Int. Cl. C08L 15/00; C09D 115/00

(52) U.S. Cl. CPC C08L 15/00; C08L 2312/00; C09D 115/00

(57) ABSTRACT

The present invention relates to vulcanizable compositions comprising HXNBR latex and polyfunctional epoxide, to processes for vulcanization of vulcanizable compositions and to mouldings composed of HXNBR vulcanizates.

The present invention relates to vulcanizable compositions comprising HXNBR latex and polyfunctional epoxide, to processes for vulcanization of vulcanizable compositions and to mouldings composed of HXNBR vulcanizates.

Rubber gloves are in widespread use and find various uses in domestic households and industry, for example in the food industry, in the electronics industry or in the medical sector. Rubber gloves must generally (1) have a pleasant fit, (2) not tear easily, i.e. have high tensile strength, and (3) remain dimensionally stable over a prolonged period of time. In addition, however, rubber gloves must also, in the case of specific applications, withstand high temperatures and be chemical-resistant.

A suitable material for production of rubber gloves is hydrogenated carboxylated nitrile rubber latex (HXNBR). HXNBR is advantageous over XNBR, since it has excellent mechanical values at elevated temperatures, relatively high heat stability and excellent ozone resistance.

In general, HXNBR in the form of solid rubber is crosslinked covalently with peroxides.

The prior art discloses different kinds of crosslinkers (=crosslinking agents or vulcanizing agents) for HXNBR latex.

EP-A-3 124 535 discloses dip-moulding latex compositions comprising HXNBR latex and, as crosslinking agent, sulfur, ZnO and organic peroxides. There is no mention of polyfunctional epoxy crosslinking agents, i.e. crosslinking agents having more than one functional epoxy group. It is also disclosed in paragraph [0012] that it is not possible to predict which latex is compatible with which crosslinking system. Crosslinking with sulfur and ZnO gives products having low elongations, high tensile strengths and simultaneously high modulus at 100% elongation (=M100 value). For use as a glove, however, low M100 values are advantageous. Heat resistance in the case of sulfur crosslinking, as known from the solid rubber, is limited to a maximum of 135° C. The ionic bridges are likewise parted above 140° C. and the material loses strength. Sulfur and sulfur-based vulcanization accelerators also have the disadvantage that dermatitis and type IV allergies can be triggered thereby.

EP-A-0 381 457 discloses that HXNBR can be crosslinked with a resorcinol-formaldehyde system as “RFL”, by means of which good strengths are obtained. However, formaldehyde is a substance that should be avoided owing to its health-endangering properties.

EP-A-2 752 475 discloses compositions comprising HXNBR latex and a crosslinking agent, wherein the acid monomer of the HXNBR is a mono-n-butyl maleate monoester or methoxyethyl acrylate (MEA). Resorcinol-formaldehyde resins are disclosed as crosslinking agents. EP-A-2 325 238 also discloses compositions composed of HXNBR suspension and resorcinol-formaldehyde resin as crosslinking agents.

WO-A-04/033573 describes the crosslinking of HXNBR latex with diisocyanates. However, isocyanates are highly toxic chemicals that are a matter of environmental concern and should therefore be avoided. WO-A-03/042309 also discloses HXNBR compositions with isocyanate crosslinking agents.

In EP-A-1 541 630 is a vulcanizable latex composition comprising a latex containing carboxyl or hydroxyl groups, for example HXNBR, a polyelectrolyte containing carboxyl or hydroxyl groups and a polyfunctional crosslinking agent which crosslinks with the carboxyl or hydroxyl groups of the polymer and the polyelectrolyte. Crosslinking agents disclosed are polyfunctional aziridines.

The prior art shows that the use of crosslinking agents known to date had disadvantages for the product properties of the dip-moulded article produced, i.e. either the crosslinking agent triggers an allergic reaction, is of environmental concern, is toxic, is insufficiently heat-stable or leads to products that do not have sufficiently high maximum elongation or tensile strength.

The known crosslinkable dip-moulding latex compositions are therefore still unsatisfactory for particular end uses.

Accordingly, a problem addressed by the present invention was that of providing crosslinkable dip-moulding latex compositions that overcome the disadvantages of the prior art, are especially less skin-irritating and environmentally compatible, and have high tensile strength, high maximum elongation and an excellent M100 value. A further problem addressed was that of providing mouldings, especially gloves, having excellent chemical resistance, heat resistance and flexibility.

The solution to the problem and the subject-matter of the present invention is thus a crosslinkable composition comprising
(a) hydrogenated carboxylated nitrile rubber latex (HXNBR latex)
(b) polyfunctional epoxide, and
(c) optionally an agent for adjusting the pH,
   wherein the composition has a pH of 9 to less than 11.

HXNBR latex was admixed with a polyfunctional epoxide and crosslinked at elevated temperatures. This gave dip-moulded articles having very high tensile strengths (Fₘₐₓ) with simultaneously high maximum elongation, and a low M100 value.

The invention further provides a process for producing vulcanizates from HXNBR latex and the vulcanized HXNBR latex mouldings produced therefrom.

It is noted at this point that the scope of the invention encompasses any and all possible combinations of the components, ranges of values, radical definitions and/or process parameters recited hereinabove and intimated hereinbelow which are general or recited in ranges of preference.

The term “copolymer” encompasses polymers having more than one monomer unit.

(a) Hydrogenated Carboxylated Nitrile Rubber Latex (HXNBR Latex)

The hydrogenated carboxylated nitrile rubbers present in the aqueous suspension are those having repeat units which derive from at least one conjugated diene, at least one α,β-unsaturated nitrile and at least one further copolymerizable termonomer containing carboxyl groups, wherein the C═C double bonds of the polymerized diene monomer have been hydrogenated to an extent of 50% to 100%, preferably to an extent of 80% to 100%, more preferably to an extent of 90% to 100% and especially to an extent of 93% to 100%.

### α,β-Ethylenically Unsaturated Nitrile

The α,β-ethylenically unsaturated nitrile used which forms the α,β-ethylenically unsaturated nitrile units may be any known α,β-ethylenically unsaturated nitrile. Preference is given to (Ca-05)-α,β-ethylenically unsaturated nitriles such as acrylonitrile, α-haloacrylonitrile, for example α-chloroacrylonitrile and α-bromoacrylonitrile, α-alkylacrylonitrile, for example methacrylonitrile, ethacrylonitrile or mixtures of two or more α,β-ethylenically unsaturated nitriles. Particular preference is given to acrylonitrile, methacrylonitrile, ethacrylonitrile or mixtures thereof. Very particular preference is given to acrylonitrile.

The amount of α,β-ethylenically unsaturated nitrile units is typically in the range from 0.1% to 50% by weight, preferably 10% to 45% by weight, more preferably from 20% to 40% by weight, based on the total amount of monomer units in the hydrogenated carboxylated nitrile rubber latex.

### Conjugated Diene

The conjugated diene which forms the conjugated diene units may be of any nature, especially conjugated C₄-C₁₂ dienes. Particular preference is given to 1,3-butadiene, isoprene, 2,3-dimethylbutadiene, 1,3-pentadiene (piperylene) or mixtures thereof. Especially preferred are 1,3-butadiene and isoprene or mixtures thereof. Very particular preference is given to 1,3-butadiene.

The amount of conjugated diene units is typically in the range from 15% to 90% by weight, preferably 20% to 75% by weight and more preferably from 25% to 65% by weight, based on the total amount of monomer units in the hydrogenated carboxylated nitrile rubber latex.

### Termonomer Containing Carboxyl Groups

Termonomers containing carboxyl groups, which form the monomer units containing carboxyl groups, are understood to mean those copolymerizable monomers which either have at least one carboxyl group in the monomer molecule or which can react in situ to release at least one carboxyl group.

Useful copolymerizable termonomers containing carboxyl groups include, for example, α,β-unsaturated monocarboxylic acids, α,β-unsaturated dicarboxylic acids, monoesters thereof or the corresponding anhydrides. Preferred copolymerizable termonomers containing carboxyl groups are α,β-unsaturated monocarboxylic acids and α,β-unsaturated dicarboxylic acids, and the monoesters thereof.

α,β-Unsaturated monocarboxylic acids used may preferably be acrylic acid and methacrylic acid. Also usable are hydroxyalkyl acrylates and hydroxyalkyl methacrylate in which the number of carbon atoms in the hydroxyalkyl groups is 1-12, preferably 2-hydroxyethyl acrylate, 2-hydroxyethyl methacrylate and 3-hydroxypropyl acrylate. Likewise usable are esters containing epoxy groups, for example glycidyl methacrylate.

Suitable copolymerizable termonomers containing carboxyl groups are additionally PEG acrylates of the general formula (I)

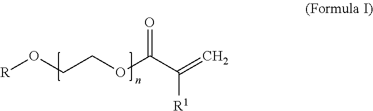

where R is hydrogen, n is 1 to 8, preferably 2 to 8, more preferably 2 to 5 and most preferably 3, and R¹ is hydrogen or CH₃—. The term “(meth)acrylate” in the context of this invention represents “acrylate” and “methacrylate”. When the R¹ radical in the general formula (I) is CH₃—, the molecule is a methacrylate. The term “polyethylene glycol” or the abbreviation “PEG” in the context of this invention represents both monoethylene glycol sections having one repeat ethylene glycol unit (PEG-1; n=1) and polyethylene glycol sections having 2 to 8 repeat ethylene glycol units (PEG-2 to PEG-8; n=2 to 8). The term “PEG acrylate” is also abbreviated to PEG-X-(M)A where “X” is the number of repeat ethylene glycol units, “MA” is methacrylate and “A” is acrylate. Acrylate units derived from PEG acrylates of the general formula (I) are referred to in the context of this invention as “PEG acrylate unit”. These PEG acrylates are commercially available, for example from Arkema under the Sartomer® trade name, from Evonik under the Visiomer® trade name or from Sigma Aldrich.

Termonomers containing carboxyl groups used may also be α,β-unsaturated dicarboxylic acids, preferably maleic acid, fumaric acid, itaconic acid, citraconic acid and mesaconic acid, or α,β-unsaturated dicarboxylic anhydrides, preferably maleic anhydride, fumaric anhydride, itaconic anhydride, citraconic anhydride and mesaconic anhydride.

It is also possible to use monoesters of α,β-unsaturated dicarboxylic acids, for example in the form of the alkyl monoesters, preferably C₁-C₁₀-alkyl monoesters, especially ethyl, n-propyl, isopropyl, n-butyl, tert-butyl, n-pentyl or n-hexyl monoesters, cycloalkyl monoesters, preferably C₆-C₁₂-cycloalkyl monoesters, more preferably C₆-C₁₂-cycloalkyl monoesters, alkylcycloalkyl monoesters, preferably C₆-C₁₂-alkylcycloalkyl monoesters, more preferably C₇-C₁₀-alkylcycloalkyl monoesters, aryl monoesters, preferably C₆-C₁₄-aryl monoesters.

Examples of α,β-unsaturated dicarboxylic monoesters include
monoalkyl maleates, preferably monomethyl maleate, monoethyl maleate, monopropyl maleate and mono-n-butyl maleate;
monocycloalkyl maleates, preferably monocyclopentyl maleate, monocyclohexyl maleate and monocycloheptyl maleate;
monoalkylcycloalkyl maleates, preferably monomethylcyclopentyl maleate and monoethylcyclohexyl maleate;
monoaryl maleates, preferably monophenyl maleate;
monobenzyl maleates, preferably monobenzyl maleate;
monoalkyl fumarates, preferably monomethyl fumarate, monoethyl fumarate, monopropyl fumarate and mono-n-butyl fumarate;
monocycloalkyl fumarates, preferably monocyclopentyl fumarate, monocyclohexyl fumarate and monocycloheptyl fumarate;
monoalkylcycloalkyl fumarates, preferably monomethylcyclopentyl fumarate and monoethylcyclohexyl fumarate;
monoaryl fumarates, preferably monophenyl fumarate;
monobenzyl fumarates, preferably monobenzyl fumarate;
monoalkyl citraconates, preferably monomethyl citraconate, monoethyl citraconate, monopropyl citraconate and mono-n-butyl citraconate;
monocycloalkyl citraconates, preferably monocyclopentyl citraconate, monocyclohexyl citraconate and monocycloheptyl citraconate;
monoalkylcycloalkyl citraconates, preferably monomethylcyclopentyl citraconate and monoethylcyclohexyl citraconate;
monoaryl citraconates, preferably monophenyl citraconate;
monobenzyl citraconate, preferably monobenzyl citraconate;
monoalkyl itaconates, preferably monomethyl itaconate, monoethyl itaconate, monopropyl itaconate and mono-n-butyl itaconate;
monocycloalkyl itaconates, preferably monocyclopentyl itaconate, monocyclohexyl itaconate and monocycloheptyl itaconate;
monoalkylcycloalkyl itaconates, preferably monomethylcyclopentyl itaconate and monoethylcyclohexyl itaconate;
monoaryl itaconates, preferably monophenyl itaconate;
monobenzyl itaconates, preferably monobenzyl itaconate;
monoalkyl mesaconates, preferably monoethyl mesaconate.

The proportion of the termonomer units containing carboxyl groups in the hydrogenated carboxylated nitrile rubber latex is in the range from 0.1% to 30% by weight, preferably 1% to 20% by weight and more preferably from 2% to 7% by weight, based on the total amount of monomer units in the hydrogenated carboxylated nitrile rubber latex.

Further Copolymerizable Monomers

The HXNBR latices may, as well as the α,β-ethylenically unsaturated nitrile units, the conjugated diene units and the termonomer units containing carboxyl groups, also include one or more further copolymerizable monomers.

Useful further copolymerizable monomers include, for example, esters of the α,β-unsaturated monocarboxylic acids. Usable esters of the α,β-unsaturated monocarboxylic acids are the alkyl esters and alkoxyalkyl esters thereof. Preference is given to the alkyl esters, especially C₁-C₁₈ alkyl esters, of the α,β-unsaturated monocarboxylic acids, particular preference to alkyl esters, especially C₁-C₁₈ alkyl esters, of acrylic acid or of methacrylic acid, especially methyl acrylate, ethyl acrylate, propyl acrylate, n-butyl acrylate, tert-butyl acrylate, 2-ethylhexyl acrylate, n-dodecyl acrylate, methyl methacrylate, ethyl methacrylate, butyl methacrylate and 2-ethylhexyl methacrylate. Preference is also given to alkoxyalkyl esters of the α,β-unsaturated monocarboxylic acids, more preferably alkoxyalkyl esters of acrylic acid or of methacrylic acid, in particular C₂-C₁₂-alkoxyalkyl esters of acrylic acid or of methacrylic acid, most preferably methoxymethyl acrylate, methoxyethyl (meth)acrylate, ethoxyethyl (meth)acrylate and methoxyethyl (meth)acrylate. Also usable are mixtures of alkyl esters, for example those mentioned above, with alkoxyalkyl esters, for example in the form of those mentioned above. Also usable are cyanoalkyl acrylates and cyanoalkyl methacrylates, having 2-12 carbon atoms in the cyanoalkyl group, preferably α-cyanoethyl acrylate, β-cyanoethyl acrylate and cyanobutyl methacrylate. Also usable are fluorine-substituted acrylates or methacrylates containing benzyl groups, preferably fluorobenzyl acrylate and fluorobenzyl methacrylate. Also usable are acrylates and methacrylates containing fluoroalkyl groups, preferably trifluoroethyl acrylate and tetrafluoropropyl methacrylate. Also usable are α,β-unsaturated carboxylic esters containing amino groups, such as dimethylaminomethyl acrylate and diethylaminoethyl acrylate.

It is also possible to use diesters of α,β-unsaturated dicarboxylic acids, for example in the form of the alkyl diesters, preferably C₁-C₁₀-alkyl diesters, especially ethyl, n-propyl, isopropyl, n-butyl, tert-butyl, n-pentyl or n-hexyl diesters, cycloalkyl diesters, preferably C₅-C₁₂-cycloalkyl diesters, more preferably C₈-C₁₂-cycloalkyl diesters, alkylcycloalkyl diesters, preferably C₆-C₁₂-alkylcycloalkyl diesters, more preferably C₇-C₁₀-alkylcycloalkyl diesters, aryl diesters, preferably C₆-C₁₄-aryl diesters, each of which may also be mixed esters.

Examples of α,β-unsaturated dicarboxylic diesters include
dialkyl maleates, preferably dimethyl maleate, diethyl maleate, dipropyl maleate and di-n-butyl maleate;
dicycloalkyl maleates, preferably dicyclopentyl maleate, dicyclohexyl maleate and dicycloheptyl maleate;
dialkylcycloalkyl maleates, preferably dimethylcyclopentyl maleate and diethylcyclohexyl maleate;
diaryl maleates, preferably diphenyl maleate;
dibenzyl maleates, preferably dibenzyl maleate;
dialkyl fumarates, preferably dimethyl fumarate, diethyl fumarate, dipropyl fumarate and di-n-butyl fumarate;
dicycloalkyl fumarates, preferably dicyclopentyl fumarate, dicyclohexyl fumarate and dicycloheptyl fumarate;
dialkylcycloalkyl fumarates, preferably dimethylcyclopentyl fumarate and diethylcyclohexyl fumarate;
diaryl fumarates, preferably diphenyl fumarate;
dibenzyl fumarates, preferably dibenzyl fumarate;
dialkyl citraconates, preferably dimethyl citraconate, diethyl citraconate, dipropyl citraconate and di-n-butyl citraconate;
dicycloalkyl citraconates, preferably dicyclopentyl citraconate, dicyclohexyl citraconate and dicycloheptyl citraconate;
dialkylcycloalkyl citraconates, preferably dimethylcyclopentyl citraconate and diethylcyclohexyl citraconate;
diaryl citraconates, preferably diphenyl citraconate;
dibenzyl citraconates, preferably dibenzyl citraconate;
dialkyl itaconates, preferably dimethyl itaconate, diethyl itaconate, dipropyl itaconate and di-n-butyl itaconate;
dicycloalkyl itaconates, preferably dicyclopentyl itaconate, dicyclohexyl itaconate and dicycloheptyl itaconate;
dialkylcycloalkyl itaconates, preferably dimethylcyclopentyl itaconate and diethylcyclohexyl itaconate;
diaryl itaconates, preferably diphenyl itaconate;
dibenzyl itaconates, preferably dibenzyl itaconate, and
dialkyl mesaconates, preferably diethyl mesaconate.

Suitable further copolymerizable monomers are PEG acrylates of the general formula (I)

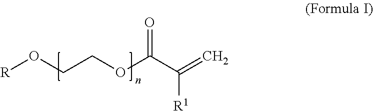

where R is branched or unbranched C₁-C₂₀-alkyl, preferably methyl, ethyl, butyl or ethylhexyl, n is 1 to 8, preferably 2 to 8, more preferably 2 to 5 and most preferably 3, and R¹ is hydrogen or CH₃—. These PEG acrylates are commercially available, for example from Arkema under the Sartomer® trade name, from Evonik under the Visiomer® trade name or from Sigma Aldrich.

The amount of the further monomer units is typically in the range from 0% to 50% by weight, preferably 0.1% to 35% by weight and more preferably from 1% to 20% by weight, based on the total amount of monomer units in the hydrogenated carboxylated nitrile rubber latex.

Preferred HXNBR latices are hydrogenated carboxylated nitrile rubber latices containing repeat units of at least one (C₃-C₃)-α,β-unsaturated nitrile, preferably acrylonitrile, methacrylonitrile, ethacrylonitrile or mixtures thereof, at least one (C₄-C₈) conjugated diene, preferably 1,3-butadiene, isoprene, 2,3-dimethylbutadiene, piperylene or mixtures thereof, and at least one further copolymerizable termonomer containing carboxyl groups, selected from the group consisting of α,β-unsaturated monocarboxylic acids, α,β-unsaturated dicarboxylic acids, monoesters thereof or the corresponding anhydrides thereof.

Particularly preferred HXNBR latices are those prepared by the hydrogenation of copolymers of

acrylonitrile/butadiene/acrylic acid, acrylonitrile/butadiene/methacrylic acid, acrylonitrile/butadiene/mono-n-butyl maleate,

acrylonitrile/butadiene/acrylic acid/butyl acrylate, acrylonitrile/butadiene/methacrylic acid/butyl acrylate, acrylonitrile/butadiene/mono-n-butyl maleate/butyl acrylate,

acrylonitrile/butadiene/acrylic acid/methoxyethyl acrylate, acrylonitrile/butadiene/methacrylic acid/methoxyethyl acrylate, acrylonitrile/butadiene/mono-n-butyl maleate/methoxyethyl acrylate,

acrylonitrile/butadiene/acrylic acid/PEG acrylate, acrylonitrile/butadiene/methacrylic acid/PEG acrylate, acrylonitrile/butadiene/mono-n-butyl maleate/PEG acrylate, acrylonitrile/butadiene/acrylic acid/PEG acrylate/butyl acrylate, acrylonitrile/butadiene/methacrylic acid/PEG acrylate/butyl acrylate, and acrylonitrile/butadiene/mono-n-butyl maleate/PEG acrylate/butyl acrylate.

### Molecular Weight

The hydrogenated carboxylated nitrile rubber latex of the invention typically has a number-average molecular weight (Mn) of 10 000 g/mol to 2 000 000 g/mol, preferably 50 000 g/mol to 1 000 000 g/mol, particularly preferably 100 000 g/mol to 500 000 g/mol and very particularly preferably 150 000 g/mol to 300 000 g/mol.

The hydrogenated carboxylated nitrile rubber latices according to the invention that are used typically have a polydispersity PDI=Mw/Mn, where Mw is the weight-average and Mn the number-average molecular weight, in the range from 2.0 to 6.0 and preferably in the range from 2.0 to 5.0.

### Hydrogenation Level

It should be explicitly emphasized at this point that, in the context of this invention, the term “HXNBR latex” comprises hydrogenated carboxylated nitrile rubber latex in which the double bonds of the conjugated diene that are originally present have been hydrogenated to an extent of at least 50%, preferably to an extent of at least 80%, more preferably to an extent of at least 90% and most preferably to an extent of at least 93%.

The HXNBR latices described in the context of this invention are also of excellent suitability for use in adhesives and batteries, for example lithium ion batteries, preferably as binder in electrodes, both anodes and cathodes, of lithium ion batteries.

### Metathesis

It is also possible that the preparation of the unhydrogenated carboxylated nitrile rubber latex is followed by a metathesis reaction to reduce the molecular weight of the unhydrogenated carboxylated nitrile rubber latex. These metathesis reactions are sufficiently well-known to those skilled in the art and are described in the literature. Metathesis is known, for example, from WO-A-02/100941 and WO-A-02/100905 and can be used to reduce the molecular weight.

### Further Latex

As well as the hydrogenated carboxylated nitrile rubber latex, further latices may also be present in the dip-moulding latex composition. Suitable further latices are natural rubber, isoprene latex, vinylpyridine latex, chlorosulfonyl-polyethylene rubber (CSM) latex, NBR latex and XNBR latex. XNBR latices are commercially available, for example from Synthomer (for example Synthomer 426D, X1138 or X115).

### Processes for Producing HXNBR Latex

HXNBR latices can be synthesized via methods known to those skilled in the art, i.e. typically via an emulsion polymerization of the corresponding aforementioned monomers to give the unhydrogenated carboxylated nitrile rubber latex (XNBR latex), followed by homogeneously or else heterogeneously catalysed hydrogenation of the aqueous unhydrogenated carboxylated nitrile rubber latex.

Processes for production of XNBR are known to those skilled in the art, for example from W. Hofmann, Rubber Chem. Technol. 36 (1963) 1 and Ullmann's Encyclopedia of Industrial Chemistry, VCH Verlagsgesellschaft, Weinheim, 1993, p. 255-261.

### Hydrogenation of the XNBR Latex

The direct hydrogenation of carboxylated nitrile rubber latex is known from the prior art. This process is described, for example, in U.S. Pat. Nos. 5,208,296, 5,210,151 and 5,783,625. Typical reaction conditions are a reaction temperature of 80 to 160° C., a hydrogen pressure of 30 to 80 bar, a transition metal catalyst of group 8, 9 or 10 and optionally an organic solvent in order to introduce the catalyst into the aqueous latex.

Alternatively, a hydrogenated nitrile rubber can be produced as secondary latex by means of dissolution of an HXNBR solid rubber in a suitable solvent with subsequent dispersion formation by addition of water, as described, for example, in EP-A-2 325 238.

The hydrogenation of carboxylated unhydrogenated nitrile rubbers in organic solvents is known, for example from U.S. Pat. No. 3,700,637, DE-A-2 539 132, DE-A-3 046 008, DE-A-3 046 251, DE-A-3 227 650, DE-A-3 329 974, EP-A-0 111 412, FR-B 2 540 503. Hydrogenated carboxylated nitrile rubbers feature not only high breaking strength, low abrasion, consistently low deformation after compressive and tensile stress and good oil resistance but also in particular remarkable stability to thermal and oxidative influences.

Incidentally, hydrogenated carboxylated nitrile rubbers as solid rubbers are also commercially available, for example under the Therban® XT trade name from ARLANXEO Deutschland GmbH.

HXNBR latex is also commercially available from Zeon under the Zetpol 2230LX trade name.

### (b) Polyfunctional Epoxide

In the context of this invention, polyfunctional epoxide are compounds having two or more epoxy groups.

In a preferred embodiment, the polyfunctional epoxide is a difunctional epoxide having two epoxy groups or a trifunctional epoxide having three epoxy groups. A particularly preferred embodiment involves a polyfunctional epoxide having two epoxy groups.

Suitable polyfunctional epoxides are bisphenol A epoxy resin, bisphenol F epoxy resins, novolak epoxy resins, biphenyl-based epoxy resins, aliphatic epoxy resins and long-chain aliphatic epoxy resins.

A preferred polyfunctional epoxide having two epoxy groups is a bisphenol A-epichlorohydrin epoxy resin commercially available under the Eudermfix GA trade name as a dispersion from LANXESS.

A preferred polyfunctional epoxide having three epoxy groups is 2-ethyl-2-(hydroxymethyl)propane-1,3-diol polymer with 2-(chloromethyl)oxirane, commercially available under the Eudermfix EP trade name as a dispersion from LANXESS.

The polyfunctional epoxide is typically present in the vulcanizable composition according to the invention in an amount of 0.1 to 50 parts by weight, preferably 0.5 to 10 parts by weight and more preferably 1 to 3 parts by weight, based on 100 parts by weight of the HXNBR latex solids.

### (c) Agent for Adjusting the pH (pH Adjuster)

Agents (c) added to adjust the pH of the dip-moulding latex compositions according to the invention may be inorganic or organic acids or bases, for example potassium hydroxide (KOH), sodium hydroxide (NaOH), ammonia or amines such as triethylamine. Preference is given to using inorganic bases, more preferably alkali metal hydroxides, most preferably KOH and NaOH, for adjusting the pH of the dip-moulding latex compositions.

The agent for adjusting the pH of the composition according to the invention is typically present in the composition according to the invention in an amount of 0 to 10 parts by weight, preferably 0.1 to 5 parts by weight, based on 100 parts by weight of the HXNBR latex solids.

The pH of the vulcanizable composition according to the invention is typically not less than 4, preferably not less than 7 and most preferably not less than 9. In addition, the pH of the vulcanizable compositions according to the invention is not more than 14, preferably not more than 13 and more preferably not more than 12. Thus, the pH of the vulcanizable compositions according to the invention is typically in the range from 4 to 14, preferably 7 to 12, more preferably 9 to 12. The pH is measured by means of conventional methods known to those skilled in the art.

In a typical embodiment of the invention, the composition according to the invention contains

(a) 100 parts by weight of HXNBR latex rubber,

(b) 0.1 to 50 parts by weight, preferably 0.5 to 10 parts by weight, more preferably 1 to 3 parts by weight, of polyfunctional epoxide and

(c) 0 to 10 parts by weight of an agent for adjusting the pH, wherein the composition has a pH of 9 to less than 11.

In a preferred embodiment, the composition according to the invention contains

(a) 100 parts by weight of HXNBR latex rubber,

(b) 0.1 to 50 parts by weight, preferably 0.5 to 10 parts by weight, more preferably 1 to 3 parts by weight, of di- or trifunctional epoxide and

(c) 0 to 10 parts by weight of an agent for adjusting the pH,

wherein the composition has a pH of 9 to 10.5.

In a further-preferred embodiment, the composition according to the invention contains

(a) 100 parts by weight of HXNBR latex solids, where the HXNBR latex includes 20% to 40% by weight of acrylonitrile units and 1% to 10% by weight of termonomer units containing carboxyl groups,

(b) 0.1 to 50 parts by weight of difunctional epoxide and

(c) 0.1 to 5 parts by weight of an agent for adjusting the pH,

wherein the composition has a pH of 9 to 10.5.

The vulcanizable composition according to the invention typically has a solids concentration of 5% to 65% by weight, preferably of 10% to 60% by weight, more preferably 15% to 55% by weight and most preferably of 20% to 40% by weight, based on the total amount of the vulcanizable composition.

### Further Vulcanizing Agents

Further vulcanizing agents used in addition to the polyfunctional epoxide (b) may in principle be any vulcanizing agents typically used in dip-moulding processes. Examples of suitable further vulcanizing agents are polyamines, for example hexamethylenediamine, triethylenetetramine and tetraethylenepentamine.

In addition to epoxide crosslinking with polyfunctional epoxide, it is possible to obtain ionic bonds by addition of metal salts, for example ZnO.

The amount of further vulcanizing agents is typically 0 to 10 parts by weight, preferably 0 to 5 parts by weight, based on 100 parts by weight of the HXNBR latex solids. In a very particularly preferred embodiment, the composition according to the invention, aside from the polyfunctional epoxide, does not contain any further crosslinking agents since these can lead to different crosslinking characteristics and inhomogeneous vulcanizate properties.

### Vulcanization Accelerator

Vulcanization accelerators used may be all vulcanization accelerators typically used in dip-moulding processes. Examples of suitable vulcanization accelerators are dithiocarbamic acid, for example diethyldithiocarbamic acid, dibutyldithiocarbamic acid, di-2-ethylhexyldithiocarbamic acid, dicyclohexyldithiocarbamic acid, diphenyldithiocarbamic acid and dibenzyldithiocarbamic acid and zinc salts thereof, for example zinc dibutyldithiocarbamate (ZDBC), 2-mercaptobenzothiazole, zinc salts of 2-mercaptobenzothiazole, 2-mercaptobenzothiazoline, dibenzothiazyl sulfide, 2-(2,4-dinitrophenylthio)benzothiazole, 2-(N,N-diethylthiocarbacylthio)benzothiazole, 2-(2,6-dimethyl-4-morpholinothio)benzothiazole, 2-(4′-morpholinedithio)benzothiazole, 4-morphonylyl-2-benzothiazyl disulfide and 1,3-bis(2-benzothiazylmercaptomethyl)urea. Preferred vulcanization accelerators are zinc dibutyldithiocarbamate (ZDBC), 2-mercaptobenzothiazole and zinc salts of 2-mercaptobenzothiazole. Vulcanization accelerators can be used either alone or in combination.

### Amount of Vulcanization Accelerator

The amount of vulcanization accelerator is preferably 0 to 10 parts by weight, more preferably 0 to 5 parts by weight and most preferably 0 to 3 parts by weight, based on 100 parts by weight of the HXNBR latex solids.

### Additives

The composition according to the invention may typically additionally contain one or more thickeners, antioxidants, ageing stabilizers, dispersants, pigments, for example titanium dioxide (TiO₂), fillers and plasticizers.

Suitable vulcanization conditions for the production of vulcanizates are sufficiently well known to those skilled in the art.

### Vulcanizates and Mouldings

The invention further provides vulcanizates and mouldings formed therefrom, produced from compositions according to the invention comprising HXNBR latex and polyfunctional epoxide. Preference is given to dip-moulded articles. The dipping process for production of dip-moulded articles, especially gloves, has already been described in detail in the prior art. It typically comprises at least the following steps: providing a dip mould, applying a coagulant and applying a latex. In addition, this dipping process comprises various washing and drying steps. Typically, this dipping process is conducted continuously, for example in what is called a chain dipping plant. For further details in this regard, reference is made to the relevant prior art.

Coagulants used are typically metal halides, for example barium chloride, calcium chloride, magnesium chloride or aluminium chloride, nitrates, for example barium nitrate, calcium nitrate or zinc nitrate, acetates, for example barium acetate, calcium acetate or zinc acetate, or sulfates, for example calcium sulfate, magnesium sulfate or aluminium sulfate. Preference is given to using the calcium salts CaCl₂ or Ca(NO₃)₂.

The coagulant is typically used in aqueous and/or alcoholic solution. The concentration of the coagulant is typically 5% to 70% by weight, preferably 20% to 50% by weight, based on the total amount of the coagulation solution.

In addition, it is possible to use surfactants (called wetting agents) such as polyoxyethylene octyl phenyl ether (Triton X-100) in the coagulation solution.

Typically, a dip mould made of porcelain, ceramic or glass is first provided. The coagulant is applied thereto in a first dipping step. For this purpose, the dip mould is dipped into a coagulation solution comprising coagulant and optionally wetting agent for a period of one second to 60 minutes and then dried. The drying can be effected at room temperature or at elevated temperature.

In a second dipping step, the latex is applied. The duration of the dipping step may be as long as desired. The dipping step typically lasts for one second to 60 minutes. In a preferred execution, the duration of the dipping step is 1 to 5 minutes, preferably 2 to 4 minutes, more preferably 2.5 to 3.5 minutes. Dip-moulded mouldings with a dipping time of 2.5 to 3.5 minutes have elevated tensile strength.

Subsequently, the coagulated latex film is dried. The drying can be effected at room temperature or at elevated temperature. In order to remove excess material or impurities, washing can be effected if desired. For this purpose, the coagulated latex film is dipped into a water bath typically having a temperature of 10 to 50° C. The dipping time for the wash is typically one second to 60 minutes, preferably 1 to 5 minutes.

Subsequently, the coagulated latex film is dried at room temperature or elevated temperature.

The vulcanization that follows the dipping process can be effected at any temperature. Typically, the film applied is vulcanized at temperatures of 90° C. to 200° C., preferably 120° C. to 190° C., and more preferably at 170° C. to 190° C.

Typically, the vulcanization is effected in a dryer. The duration of the vulcanization depends on the rubber and the crosslinking system used and is typically 1 to 60 minutes, preferably 10 to 20 minutes.

The invention further provides vulcanizates of hydrogenated carboxylated nitrile rubber latex, preferably dip-moulded articles or coatings, more preferably gloves, produced by the vulcanization of the vulcanizable compositions according to the invention.

The invention further provides a coated carrier material which has been coated with the vulcanizable composition according to the invention. For this purpose, the carrier material is dipped into a dip-moulding latex composition according to the invention comprising HXNBR latex (a) and polyfunctional epoxide (b) as crosslinking agent.

The invention further provides a process for producing composite materials, which is characterized in that the coated carrier material is embedded into one or more further rubbers and auxiliaries and vulcanized, the rubbers preferably being selected from the group consisting of NR, BR, SBR, EPM, EPDM, ECO, CR, EVM, CSM, ACM, VMQ, FKM, NBR, HNBR and mixtures, and the auxiliaries preferably comprising fillers, crosslinking agents and crosslinking accelerators.

The composite materials find use in a wide variety of different fields of use, preferably as reinforced articles of any kind, more preferably as fibre-reinforced articles of any kind, especially as belts of all kinds, membranes, bellows, air springs, rubber muscles and hoses.

The invention further relates to the use of polyfunctional epoxides as crosslinking agents for HXNBR latex.

The invention further relates to the use of the compositions according to the invention comprising hydrogenated carboxylated nitrile rubber latex and polyfunctional epoxide for production of vulcanizates of hydrogenated carboxylated nitrile rubber latex, preferably for production of dip-moulded articles or coatings, more preferably for production of gloves.

The particular advantage of the invention is that vulcanizates produced by the vulcanization of hydrogenated carboxylated nitrile rubber latex and polyfunctional epoxide have a low M100 value with simultaneously high elongation and tensile strength.

### EXAMPLES

### Materials Used

Latex (a)

| | |
|---|---|
| Therban ® | hydrogenated carboxylated secondary NBR latex; |
| XT-Latex | pH = 8.7; 40% by weight of solids; 33% by weight |
| | of acrylonitrile; 5% by weight of methacrylic acid; |
| | commercially available from ARLANXEO |

Crosslinking agent (b)

| | |
|---|---|
| Polyfunctional | EUDERM Fix GA-I (bisphenol A-epichlorohydrin |
| epoxide | epoxy resin with average molecular weight <700); |
| | available from LANXESS |
| Resorcinol | available from VWR Chemicals, 99.1% |
| Formaldehyde | available from VWR Chemicals, 36% |
| Sulfur | 50% colloidal sulfur dispersion, available from |
| | agrostulln GmbH |

Auxiliaries

| | |
|---|---|
| ZDBC | vulcanization accelerator; zinc dibutyldithiocarbamate |
| | dispersion; available from Aquaspersions, 50% |
| ZnO | zinc oxide; available from Aquaspersions, 50% |

Coagulation solution

| | |
|---|---|
| Ca(NO₃)₂*4 H₂O | calcium nitrate tetrahydrate; available from VWR |
| Triton X-100 | surfactant; available from Merck |

pH adjuster

| | |
|---|---|
| NaOH | sodium hydroxide; available from Merck, 99% |
| KOH | potassium hydroxide; available from VWR |
| NH₄OH | ammonia solution; available from Merck, 28-30% |

### Measurement of Tensile Strength and Elongation

The measurement of the tensile strengths was conducted in a tensile tester from Zwick/Roell (model Z005, XForce HP load cell). For this purpose, four S2 tensile specimens (to DIN 53504:2009-10, adapted to ISO37-2005) were punched out of the latex film obtained and clamped into the jaws of the tensile tester. Subsequently, the jaws were pulled apart at a defined speed, and force and distance were recorded. The force at which the sample tears is determined as Fₘₐₓ. The median over all four tensile tests is reported. The force is based on the width (4 mm) and the layer thickness of the tensile specimen measured, and is reported in MPa.

### Measurement of M100

M100 is a measure of the wearing comfort and stiffness of mouldings, for example gloves. The lower the M100 value, the greater the wearing comfort. The force from the tensile test at which the S2 specimen has been extended by 100% is used as M100. The median over all four tensile tests is reported. The force is based on the width (4 mm) and the layer thickness of the tensile specimen measured, and is reported in MPa.

### Procedure for the Dipping Experiments

Glass plates (10×14 cm) were first dipped into a coagulation solution. The coagulation solution contained 22% by weight of calcium nitrate (Ca(NO₃)₂), 0.025% by weight of Triton X-100 and surfactant. In a glass chamber, the dip-moulding latex composition was prepared. The glass plates were then dipped once into the dip-moulding latex composition for 3 minutes. The films produced in this way were dried at 25° C. for 3 minutes and then washed in a water bath at 40° C. for 3 minutes. After drying again at 130° C. for 10 minutes, the films obtained were vulcanized in an oven at elevated temperatures for 10 minutes. The latex films obtained were parted cautiously from the mould and the layer thickness was measured. The layer thicknesses of the films thus produced were between 0.19 and 0.42 mm.

### 1. Epoxide Crosslinker (Inventive):

### Production of the Dip-Moulding Latex Composition

A beaker was charged with the HXNBR latex (a). The appropriate amount of epoxide (b) was added while stirring. It should be noted that the amounts of crosslinker stated are based on the mass of the crosslinker present in the overall dip-moulding latex composition and on the HXNBR solids dispersed in the dip-moulding latex composition. Subsequently, dilute KOH (10% by weight) was used to adjust the pH to the desired value. The dip-moulding latex compositions were then adjusted to a solids content of 35% with deionized water.

TABLE 1
Effect of the pH of the dip-moulding latex composition on the
properties of the dip-moulded articles made from HXNBR
latex with epoxide as crosslinking system

| | V1 | V2 | V3 | V4 | V5 |
|---|---|---|---|---|---|
| (a) HXNBR latex solids [parts by wt.] | 100 | 100 | 100 | 100 | 100 |
| (b) Euderm GA [parts by wt.] | 3 | 3 | 3 | 3 | 3 |
| pH | 9 | 9.5 | 10 | 10.5 | 11 |
| Solids content [%] | 35 | 35 | 35 | 35 | 35 |
| Fₘₐₓ [MPa] | 9 | 10 | 13 | 17 | 23 |
| M100 [MPa] | 1.00 | 1.09 | 1.28 | 1.80 | 3.14 |
| Elongation [%] | 681 | 619 | 505 | 407 | 331 |

Vulcanization time: 10 minutes; vulcanization temperature: 180° C.

The vulcanization and hence the properties of the vulcanized HXNBR latices, i.e. of the dip-moulded articles produced, are dependent on the pH of the dip-moulding latex composition. With falling pH, the dip-moulding composition turns yellowish to brownish. With rising pH, the viscosity of the formulation increases.

Dip-moulded articles that are produced from dip-moulding latex compositions having a pH of 9 to 10.5 have an exceptionally low and hence advantageous M100 value of less than 2.0 MPa.

TABLE 2
Effect of the vulcanization temperature on the properties of the
dip-moulded articles made from HXNBR latex with
polyfunctional epoxide as crosslinking system
The vulcanizable compositions from experiment V4 were
determined at different vulcanization temperatures and then the
tensile strength was determined.

| | V4.1 | V4.2 |
|---|---|---|
| Vulcanization temperature [° C.] | 150 | 170 |
| Fₘₐₓ [MPa] | 10 | 13 |

Vulcanization time: 10 minutes

Vulcanizates that have been crosslinked at an elevated vulcanization temperature above 170° C. have excellent tensile strengths (see also V4 in Table 1).

TABLE 3
Effect of the amount of crosslinker on the properties of the dip-moulded articles
made from HXNBR latex with polyfunctional epoxide as crosslinking system

| | V6 | V4 | V5 | V7 | V8 | V9 |
|---|---|---|---|---|---|---|
| (a) HXNBR latex solids [parts by wt.] | 100 | 100 | 100 | 100 | 100 | 100 |
| (b) Euderm GA [parts by wt.] | 1 | 3 | 3 | 5 | 5 | 10 |
| pH | 11 | 10.5 | 11 | 10.5 | 11 | 11 |
| Solids content [%] | 35 | 35 | 35 | 35 | 35 | 35 |
| Fₘₐₓ [MPa] | 19 | 17 | 23 | 17.5 | 24 | 19 |

Vulcanization time: 10 minutes; vulcanization temperature: 180° C.

At high pH values of 10.5 to 11, the addition of 5 parts by weight of polyfunctional epoxide based on 100 parts by weight of HXNBR latex solids leads to a slight improvement in tensile strength. In the case of elevated proportions of polyfunctional epoxide, a reduction in tensile strength can be observed.

### 2. RFL Crosslinker (Noninventive)

Resorcinol and formaldehyde are pre-condensed in water under basic conditions at room temperature overnight to give the premix.

TABLE 4
Premix composition

| | Comparative | Comparative |
|---|---|---|
| | experiment 1 | experiment 2* |
| Premix | [parts by wt.] | [parts by wt.] |
| Resorcinol | 11.0 | 11.0 |
| Formaldehyde (37% solution) | 16.2 | 8.1 |
| Deionized water | 235.8 | 194 |
| NaOH (10% solution) | 3.0 | 3.0 |

Thereafter, the dip-moulded latex composition is prepared by adding premix and further substances (NH₄OH) to the HXNBR latex.

TABLE 5
Dip-moulding latex composition

| | Comparative | Comparative |
|---|---|---|
| Dip-moulding latex | experiment VV1 | experiment VV2 |
| composition | [parts by wt.] | [parts by wt.] |
| HXNBR latex | 244^{a} | 60.9^{b} |
| Premix | 266 | 27.7 |
| Water | 60 | 11.4 |
| NH₄OH | 11 | 0 |
| (28% solution) | | |

^{a}41% solution;
^{b}30% solution

The RFL formulation was dipped analogously to the epoxide-containing dip-moulding compositions according to the invention. It was not possible to obtain any films with the dip-moulding latex composition from comparative experiment 1. After drying, significant shrinkage and large cracks were observed, and so it was not possible to punch any suitable specimens for a tensile test out of the films.

With the same procedure as for the epoxide-containing dip-moulding latex compositions, it was possible to use the dip-moulding latex composition from comparative experiment 2 to obtain films, out of which it was possible to punch tensile specimens.

TABLE 6
Effect of the vulcanization temperature on the properties
of the dip-moulded articles made from HXNBR latex
with RFL as crosslinking system

| | VV2.1 | VV2.2 |
|---|---|---|
| Vulcanization temperature [° C.] | 120 | 170 |
| Fₘₐₓ [MPa] | 17.5 | 21.4 |
| M100 [MPa] | 4.1 | 4.2 |
| Elongation [%] | 506 | 494 |

While the vulcanizates have good tensile strength coupled with high elongation, the M100 values obtained are too high for use as gloves.

### 3. Sulfur/ZnO Crosslinker (Noninventive)

A beaker was charged with the HXNBR latex. While stirring, the appropriate amount of sulfur, ZnO and ZDBC was added. It should be noted that the amounts of crosslinker stated are based on the mass of the crosslinker present in the overall dip-moulding latex composition and on the HXNBR solids dispersed in the dip-moulding latex composition. Subsequently, dilute KOH (10% by weight) was used to adjust the pH to the desired value. The dip-moulding latex compositions were then adjusted to a solids content of 35% with deionized water.

TABLE 7
Properties of the dip-moulded articles made from
HXNBR latex with sulfur/ZnO as crosslinking system

| | Comparative |
|---|---|
| | experiment VV3 |
| HXNBR latex solids [parts by wt.] | 100 |
| Sulfur [parts by wt.] | 0.5 |
| ZnO [parts by wt.] | 5.0 |
| ZDBC [parts by wt.] | 0.25 |
| pH | 9.0 |
| Solids content [%] | 35 |
| Fₘₐₓ [MPa] | 37.2 |
| M100 [MPa] | 2.9 |
| Elongation [%] | 413.0 |

Vulcanization conditions: 20 minutes at 125° C.

Dip-moulded articles made from HXNBR latex with sulfur/ZnO crosslinking do have very high tensile strengths, but at the same time have much too high a M100 value of well over 2.0 MPa.

TABLE 8
Effect of the vulcanization temperature on the properties
of the dip-moulded articles made from HXNBR latex
with sulfur as crosslinking system

| | VV3.1 | VV3.2 |
|---|---|---|
| Vulcanization temperature [° C.] | 100 | 125 |
| Fₘₐₓ (median) [MPa] | 10 | 37 |

In the case of a vulcanization temperature of 125° C., elevated tensile strength was measured in the HXNBR latex.

1. A composition comprising:
(a) hydrogenated carboxylated nitrile rubber latex (HXNBR latex),
(b) polyfunctional epoxide, and
(c) optionally a pH adjusting agent,
wherein the composition has a pH of 9 to less than 11.

2. The composition of claim 1, wherein the hydrogenated carboxylated nitrile rubber latex has been hydrogenated at least 50%.

3. The composition of claim 1, wherein the hydrogenated carboxylated nitrile rubber latex includes 0.1% to 50% by weight, of nitrile monomer units, based on the total amount of monomer units in the hydrogenated carboxylated nitrile rubber latex.

4. The composition of claim 1, wherein the hydrogenated carboxylated nitrile rubber latex includes from 0.1% to 30% by weight, of termonomer units containing carboxyl groups, based on the total amount of monomer units in the hydrogenated carboxylated nitrile rubber latex.

5. The composition of claim 1, wherein the polyfunctional epoxide (b) is a di- or trifunctional epoxide.

6. The composition of claim 1, wherein the composition contains
(a) 100 parts by weight of HXNBR latex rubber,
(b) 0.1 to 50 parts by weight, of polyfunctional epoxide and
(c) 0 to 10 parts by weight of the pH adjusting agent, and,
wherein the composition has a pH of 9 to less than 11.

7. The composition of claim 1, comprising (c) 0.1 to 5 parts by of the pH adjusting agent, based on 100 parts by weight of HXNBR latex solids.

8. The composition of claim 1, wherein the (c) pH adjusting agent is a base.

9. The composition of claim 1, wherein the HXNBR latex solids present in the composition is 5% to 65% by weight, based on the total weight of the composition.

10. A process of producing a composition according to claim 1, wherein the process occurs at a temperature in the range of 90° C. to 200° C.

11. Articles or coatings comprising a composition according to claim 1.

12. Articles or coatings formed by the process according to claim 10.

13. A composition of claim 1, wherein the composition comprises:
(c) a pH adjusting agent.

14. The composition of claim 8, wherein the (c) pH adjusting agent is an inorganic base.

15. The composition of claim 2, wherein the hydrogenated carboxylated nitrile rubber latex has been hydrogenated at least 80%.

16. The composition of claim 15, wherein the hydrogenated carboxylated nitrile rubber latex has been hydrogenated at least 90%.

17. The composition of claim 3, wherein the hydrogenated carboxylated nitrile rubber latex includes 10% to 45% by weight of the nitrile monomer units.

18. The composition of claim 4, wherein the hydrogenated carboxylated nitrile rubber latex includes 1% to 20% by weight, of the of termonomer units containing carboxyl groups.

19. The composition of claim 5, wherein the polyfunctional epoxide (b) is a difunctional epoxide.

20. The process of claim 10, wherein the process occurs at a temperature in the range of 120° C. to 190°.
